(19) United States
(12) Patent Application Publication
(10) Pub. No.: US 2013/0151444 A1
(43) Pub. Date: Jun. 13, 2013

(54) METHODS AND APPARATUS FOR UTILISING SOLUTIONS TO SAT PROBLEMS

(71) Applicant: ISIS INNOVATION LIMITED, Oxford (GB)

(72) Inventors: Matthew Brian Blaschko, Oxford (GB); Alex Flint, Oxford (GB)

(73) Assignee: ISIS INNOVATION LIMITED, Oxford (GB)

(21) Appl. No.: 13/708,693

(22) Filed: Dec. 7, 2012

(30) Foreign Application Priority Data
Dec. 9, 2011 (GB) 1121216.4

(51) Int. Cl. G06N 99/00

(52) U.S. Cl. 706/12

(57) ABSTRACT

Computer implemented method to indicate whether a CNF sentence representing a physical system is satisfiable. The method includes structuring a search tree based upon received data representing the CNF sentence. The search tree includes a root node and a plurality of other nodes. The method includes causing the computer to use a search to visit nodes using a decision heuristic at each node to determine which of the branches of the search tree to explore from that node, determining which nodes lie on the solution path, modifying the decision heuristic according to the analysis, generating a trained decision heuristic, and using the trained decision heuristic to process CNF sentences to determine whether those CNF sentences are satisfiable. A shortest path through the search tree provides a solution path and the heuristic can be trained with a set of training instances.

### CROSS-REFERENCE TO RELATED APPLICATIONS

This application claims priority to GB Patent App. No. 1121216.4, filed Dec. 9, 2011, which is hereby incorporated by reference in its entirety.

### FIELD

This application relates to methods and apparatus for solving SAT problems. In particular the methods may find application in any of the following areas: hardware verification, software verification, product configuration, planning and scheduling, theorem proving, circuit equivalence checking, cryptanalysis, bioinformatics, planning for mining, etc. Implementations of the invention may provide a specific hardware, firmware and/or software apparatus/method directed to any of these, or other, areas.

### BACKGROUND

Boolean satisability (SAT) as a canonical NP-complete decision problem is one of the most important problems in computer science. Many real world phenomenon can be written as conjunctive normal form (CNF) sentences and whether or not a solution exists to the CNF sentence determines whether or not the real world phenomenon is possible. However, the skilled person will appreciate that as the complexity of the real world phenomenon increases then the complexity of the CNF sentence increases at a faster rate. As such, solving the problem provided by the CNF sentence in less than exponential time finds use in many different fields. Therefore, it becomes a technical challenge to reduce the power of hardware needed to solve the canonical sentences.

Many methods of processing SAT problems structure the problem as a depth first search according to the Davis-Putnam-Logemann-Loveland (DPLL) method (M. Davis and H. Putnam. A computing procedure for quantication theory. J. ACM, 7:201{215, 1960} & M. Davis, G. Logemann, and D. Loveland. A machine program for theorem-proving. Commun. ACM, 5:394{397, July 1962}). A significant number of methods for solving SAT problems have been proposed and competitions are run to determine the fastest solvers. Whilst much recent work has focussed on choosing heuristics for the selection of branching literals (since good heuristics have been empirically shown to reduce processing time by several orders of magnitude) none of the proposed solutions solve the problems as quickly as may be desired and thus, there is a desire to use limited processing power more efficiently.

A number of authors have considered learning branching rules for SAT solvers. An approach that has performed well in SAT competitions in recent years is based on selecting a heuristic from a fixed set and applying it on a per-sentence (e.g., per canonical sentence) basis.

### SUMMARY

According to a first aspect of the invention there is provided a computer implemented method for deciding satisfiability (SAT) of Conjunctive Normal Form (CNF) sentences. The method may comprise structuring a satisfiability solver as a search tree comprising a root node and a plurality of other nodes. Subsequently the method may cause the computer to use a search to visit nodes of the tree thereby searching the search tree, which may be a depth first search. Typically the search uses a decision heuristic at each node to determine which of the branches of the search tree to explore. The computer may learn the decision heuristic from a plurality of training instances, where the method may further comprise causing the computer to perform at least one of the following:
a. run the search on one of the plurality of training instances until a solution path, providing the shortest route from the root node through the search tree to a solution node, is located;
b. analyse the nodes visited during the search of the tree to determine which nodes lie on the solution path;
c. modify the decision heuristic according to the analysis in step b; and
d. repeat the method on a further training instances until the further modification of the decision heuristic is determined not to be necessary such that a trained decision heuristic is generated.

The method may subsequently be run on CNF sentences to determine whether or not they are satisfiable. As such, a CNF sentence representing a physical situation may be generated and input to the method and the trained decision heuristic used to determine whether or not the CNF sentence is satisfiable.

Embodiments of such an invention therefore approach the exploration of a family of SAT solvers as a learning problem and empirical results show an order of magnitude improvement over a state-of-the-art SAT solver on a hardware verification task.

According to a second aspect of the invention there is provided a machine readable medium containing instructions which when read by a machine cause that machine to decide satisfiability (SAT) of CNF sentences. The instructions may cause the machine to structure a satisfiability solver as a search tree comprising a root node and a plurality of other nodes. The instructions may subsequently cause the machine to use a depth first search to visit nodes of the tree thereby searching the search tree. Typically the instructions will cause the machine to uses a decision heuristic at each node, during the depth first search, to determine which of the branches of the search tree to explore. The instructions may cause the machine to learn the decision heuristic from a plurality of training instances, where the instructions may further cause the machine to perform at least one of the following:
a. run the search on one of the plurality of training instances until a solution path, providing the shortest route from the root node through the search tree to a solution node, is located;
b. analyse the nodes visited during the search of the tree to determine which nodes lie on the solution path;
c. modify the decision heuristic according to the analysis in step b; and
d. repeat the method on a further training instances until the further modification of the decision heuristic is determined not to be necessary such that a trained decision heuristic is generated.

A third aspect of the invention provides a computer system arranged to run the method of the first aspect of the invention or to execute the instructions of the second aspect of the invention.

According to a fourth aspect of the invention there is provided computer implemented method arranged to indicate whether a Conjunctive Normal Form (CNF) sentence representing a physical system is satisfiable. The method may learn a decision heuristic from a set of training instances and the method may comprise causing the computer to receive data representing the CNF sentence and to structure that data as a search tree comprising a root node and a plurality of other nodes. The method may subsequently comprise causing the computer to perform at least one of the following:
a. use a depth first search to visit nodes of the tree thereby searching the search tree, wherein the depth first search uses a decision heuristic at each node to determine which of the branches of the search tree to explore from that node. The search may be run on one of the set of training instances until a solution path, providing the shortest route from the root node through the search tree to a solution node is located;
b. analyse the nodes visited during the search of the tree to determine which nodes lie on the solution path;
c. modify the decision heuristic according to the analysis in step b;
d. repeat the method on a further training instances until the further modification of the decision heuristic is determined not to be necessary such that a trained decision heuristic is generated;
e. subsequently use the trained decision heuristic to process CNF sentences in addition to the training set to determine whether those CNF sentences are satisfiable.

The method may make an output as to whether the CNF sentence is satisfiable.

According to a fifth aspect of the invention there is provided a machine readable medium containing instructions which when read by a machine cause that machine to indicate whether a Conjunctive Normal Form (CNF) sentence representing a physical system is satisfiable. The instructions may cause the machine to learn a decision heuristic from a set of training instances and the instructions may further cause the machine to receive data representing the CNF sentence and to structure that data as a search tree comprising a root node and a plurality of other nodes. The instructions may subsequently causing the machine to perform at least one of the following:
a. use a depth first search to visit nodes of the tree thereby searching the search tree, wherein the depth first search uses a decision heuristic at each node to determine which of the branches of the search tree to explore from that node. The search may be run on one of the set of training instances until a solution path, providing the shortest route from the root node through the search tree to a solution node is located;
b. analyse the nodes visited during the search of the tree to determine which nodes lie on the solution path;
c. modify the decision heuristic according to the analysis in step b;
d. repeat the method on a further training instances until the further modification of the decision heuristic is determined not to be necessary such that a trained decision heuristic is generated;
e. subsequently use the trained decision heuristic to process CNF sentences in addition to the training set to determine whether those CNF sentences are satisfiable.

According to a sixth aspect of the invention provides a computer system arranged to run the method of the fourth aspect of the invention or to execute the instructions of the sixth aspect of the invention.

Thus, embodiments of the invention may provide systems for checking, verifying, designing and/or manufacturing real world systems.

Thus, according to a seventh aspect of the invention a hardware verification system is provided in which the system is arranged to verify whether the hardware functions correctly by performing the following steps:
a) generate a Boolean expression of the hardware;
b) run the method of the first or fourth aspects of the invention on the Boolean expression; and
c) determine whether the hard functions correctly according to whether the Boolean expression is satisfiable.

The skilled person will appreciate that whether there is an error within the hardware can be deduced from whether the Boolean expression (which may be a CNF sentence) is satisfiable. It is known that in some embodiments, the Boolean expression is verified if it is satisfiable, whereas in other embodiments, the Boolean expression is structure if it is unsatisfiable.

A method of verifying hardware may be provided.

Similarly, software verification systems and/or methods may be provided. Verification systems for any of the other applications described and/or at least mentioned herein may also be provided.

According to a further aspect of the invention, there is provided a method of designing an electronic circuit, comprising generating a design for the circuit, checking the design using the seventh aspect of the invention and revising the design if the SAT search indicates that the circuit is incorrect.

Other aspects of the invention may provide design methods for any of the other applications described herein.

The machine readable medium of any of the above aspects of the invention may comprise any of the following types of medium: a floppy disc; a CD ROM/RAM; a DVD ROM/RAM (including +R/+RW and −R/−RW); any other form of optical disc or magneto optical disc; a computer memory (including SD cards, mini SD and micro SC cards; Compact Flash; USB memory sticks, etc); hard drives; Downloads (including Internet downloads, FTP transfers, etc.); a wire.

The skilled person will appreciate that a feature discussed in relation to any of the above aspects of the invention may be used, mutatis mutandis, to any of the other features of the invention.

### BRIEF DESCRIPTION OF THE DRAWINGS

There now follows by way of example only a detailed description of an embodiment of the present invention with reference to the accompanying drawings in which:

FIG. 1 shows a computer system arranged to provide a method according to an embodiment of the invention;

FIG. 2 highlights a search tree used in an embodiment of the invention;

FIG. 3 shows the geometry of a feature space;

FIG. 4 shows the results of an embodiment of the invention applied to an SAT problem in the field of planar graph colouring;

FIG. 5 shows the results of an embodiment of the invention applied to an SAT problem in the field of hardware verification; and

FIG. 6 outlines a flow chart showing the method as used in an embodiment of the invention.

### DETAILED DESCRIPTION OF THE DRAWINGS

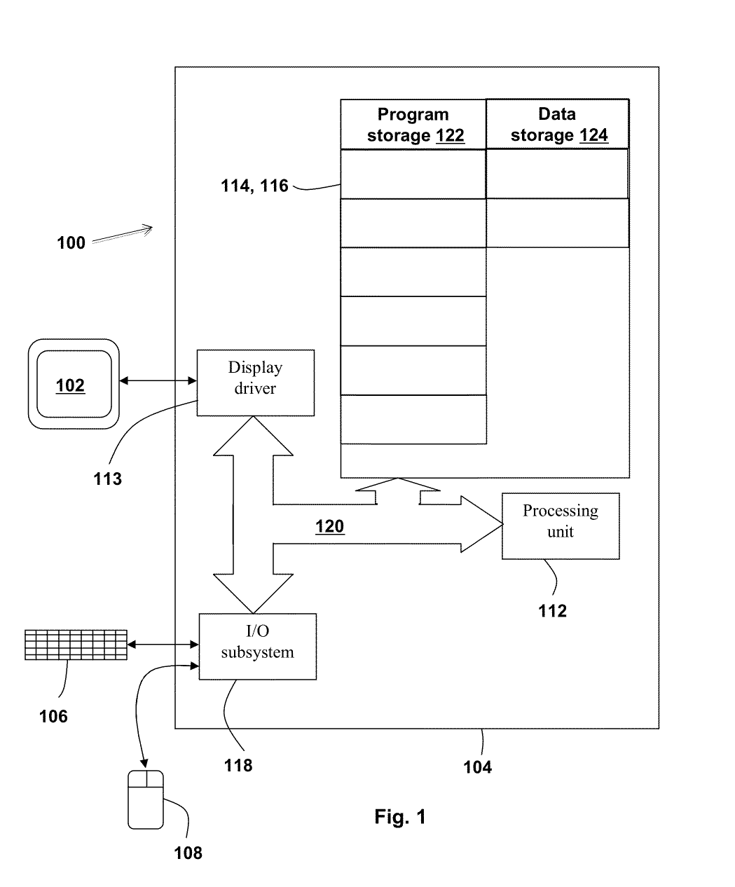

The computer system 100 of FIG. 1 exemplifies a computer system that may be used to provide the computer implemented methods described herein or as a computer system described herein. The computer system 100 comprises a display 102, processing circuitry 104, a keyboard 106 and a mouse 108. The processing circuitry 104 comprises a processing unit 112, a graphics system 113, a hard drive 114, a memory 116, an I/O subsystem 118 and a system bus 120. The processing unit 112, graphics system 113 hard drive 114, memory 116 and I/O subsystem 118 communicate with each other via the system bus 120, which in this embodiment is a PCI bus, in a manner well known in the art.

The graphics system 113 comprises a dedicated graphics processor arranged to perform some of the processing of the data that it is desired to display on the display 102. Such graphics systems 113 are well known and increase the performance of the computer system by removing some of the processing required to generate a display from the processing unit 112.

It will be appreciated that although reference is made to a memory 116 it is possible that the memory could be provided by a variety of devices. For example, the memory may be provided by a cache memory, a RAM memory, a local mass storage device such as the hard disk 114, any of these connected to the processing circuitry 104 over a network connection. However, the processing unit 112 can access the memory via the system bus 120 to access program code to instruct it what steps to perform and also to access data to be processed. The processing unit 112 is arranged to process the data as outlined by the program code.

Indeed, in some embodiments of the invention it is entirely possible that a number of computer systems 100, processing circuits 104 and/or processing units 112 may be connected in parallel in order to provide the method and/or computers systems described herein.

A schematic diagram of the memory 114,116 of the computer system is shown in FIG. 1. It can be seen that the memory comprises a program storage portion 122 dedicated to program storage and a data storage portion 124 dedicated to holding data.

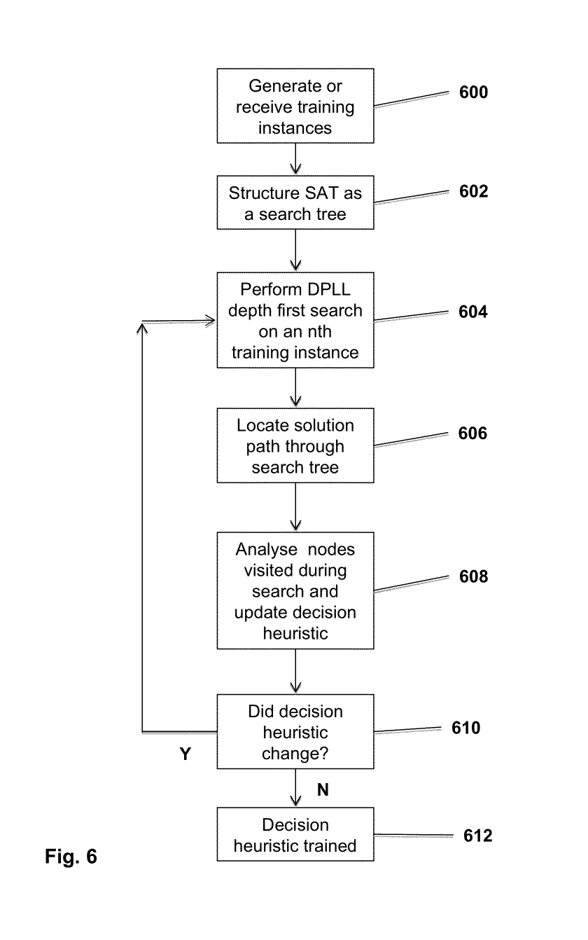

An embodiment of the invention is now described with the aid of the Figures, including the flow chart of FIG. 6. The description also exemplifies how other embodiments of the invention may perform parts of the embodiment being described in a different manner.

SAT instances generated from real world applications (e.g., those applications which represent physical systems) are likely to have shared characteristics and substructures. As such, those SAT instances may be view as being drawn from a distribution over SAT instances, and for problems this distribution may be benign in that a learning algorithm can enable quick determination of SAT.

As such, embodiments of the invention may generate SAT instances for processing as an initial stage of the method. Alternative embodiment may of course receive SAT instances that have already been generated. This is shown at 600 in FIG. 6.

Thus, once SAT instances are available (either by generation or being received) some embodiments of this invention apply a perceptron inspired learning method to branching heuristics in the Davis-Putnam-Logemann-Loveland method. Other embodiments may apply other learning techniques. For example, other embodiments may employ any form of statistical learning, which may for example be by way of risk minimization or Baysian inference.

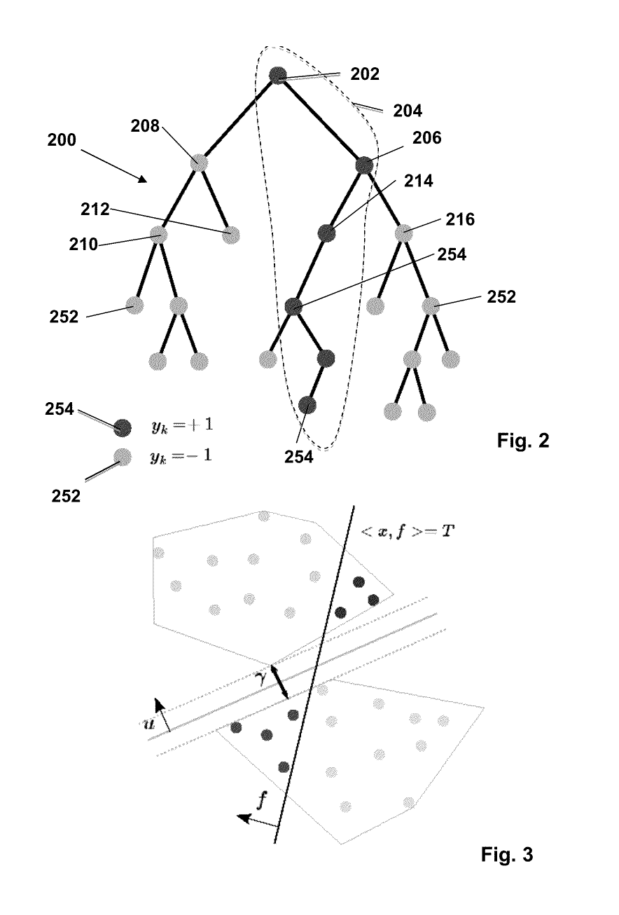

As the skilled person will appreciate, the Davis-Putnam-Logemann-Loveland (DPLL) method formulates SAT as a search problem, using a search tree 200, which results in a valuation of variables that satisfies the sentence, or a tree resolution refutation proof indicating that the sentence is not satisfiable. Such a search is exemplified in FIG. 2 and shows that the satisfiability solver has been represented as a search tree 200 (step 602 of FIG. 6). Whilst the embodiment of the invention being described uses a depth first search strategy, other search strategies could be used to explore the search tree 200. For example, other embodiments of the invention may use a breadth first strategy, a best first strategy, or the like.

The search tree 200 comprises a root node 202 together with two leaves emanating therefrom and each connected to another node. As such the search tree 200 comprises a plurality of other nodes each of which represents a particular assignment of variables to the SAT instance.

In the depth first search, a branching rule is a determinant of the efficiency of the method, and numerous heuristics have been proposed in the SAT literature. Embodiments of this invention use a learning process to improve the heuristic that is used to explore the search tree 200, as shown in FIG. 2. Efficient learning of SAT may significantly reduce the computing resources required for a number of problems. These problems find real world application (such as hardware verification; software verification; biomedical halotypes; or any other physical system) and as such being able to determine whether a Conjunctive Normal Form (CNF) sentence is satisfiable provides real world utility. It is currently a technical challenge to address such problems which, due to increasing complexity creating ever more lengthy problems, is not readily addressed simply by using faster computer hardware. Currently the complexity of problems is increasing at a faster rate that the power of computer hardware.

As the skilled person will appreciate, the SAT problem is to determine whether a sentence in propositional logic is satisifable; e.g. a Boolean expression. As an example, a binary variable q takes on one of two possible values −{0, 1}. A literal p is a proposition of the form q (a “positive literal”) or [symbol] q (a “negative literal”). Thus, a clause ωₖ is a disjunction of nₖ literals:

p₁ [symbol] p₂ [symbol] . . . [symbol] pₙ_{ₖ}. (1)

A unit clause contains exactly one literal. A sentence Ω in conjunctive normal form (CNF) is a conjunction of m clauses,

ω₁ [symbol] ω₂ [symbol] . . . [symbol] ωₘ. (2)

A valuation B for Ω assigns to each variable in Ω a value bᵢε{0, 1}.

A variable is free under B if B does not assign it a value. A sentence Ω is satisfiable if there exists a valuation under which Ω is true. CNF is considered a canonical representation for automated reasoning systems. All sentences in propositional logic can be transformed to CNF.

Thus, returning to the search tree 200 of FIG. 2, each node thereof represent a particular assignment of variables to the CNF sentence representing the SAT instance, with the root node 202 representing the CNF sentence with no variable assignment thereto. Since each of the variables within the CNF sentence is a binary variable then all possible states for that variable can be represented by two nodes and as such, at each node, a decision is made as to the state of one of the variables from the sentence.

Thus, at the root node 202 a decision is made as to the state of a first variable of sentence (e.g., the Boolean expression) and the two nodes 206, 208 emanating from the root node 202 represent the sentence with that first variable set; for example the node 206 may represent the first variable set to TRUE and the node may represent the first variable set to FALSE. Thus, the nodes 206, 208 lie at a first level of the search tree. The skilled person will appreciate that a path from one (e.g. the root node 202) to another node (e.g. node 206) may be thought of as a branch.

Nodes 210,212,214,216 emanating from the nodes 206, 208 then represent the CNF sentence with a second variable set and lie at a second level of the tree 200. This structure is repeated for each of the variables within the CNF sentence and thus the tree has N levels where N corresponds to the number of variables in the CNF sentence and there are consequently 2^{N} nodes within the tree 200.

In a typical real world SAT instance there may typically be 10's or 100's of thousands of variable within the CNF sentence. For example, embodiments of the invention have been tested on examples containing roughly 30,000 variables.

The skilled person will appreciate how to generate a CNF sentence representing the physical, real-world, situation. An example of how this may be performed in the hardware verification field is shown at: http://repository.cmu.edu/cgi/viewcontent.cgi?article=1458&context=compsci. The contents of this document are hereby incorporated by reference and the skilled person is directed to read this document to understand how a CNF sentence can be generated from a Bounded Model Checking (BMC) problem. Thus, embodiments of the invention may be used to provide BMC/hardware verification.

Further, as an illustrative example, embodiments of the invention may solve instances of graph colouring (GC) problems, which asks whether the vertices comprising a graph can be each identified with colours such that no pair of adjacent nodes are assigned the same colour, where the range of colours is limited to some finite quantity. As such, a CNF sentence can be generated from the problem and it determined whether or not the sentence is satisfiable. If the sentence is satisfiable then a solution to the GC problem exists and the graph can be coloured so that no pair of adjacent nodes are assigned the same colour. If the sentence is not satisfiable then there is no solution to the GC problem.

For a GC problem involving K colours and a graph with N vertices, the CNF sentence will contain N*K variables, denoted Vᵢₖ below. The first N clauses will constrain solutions to assign a colour to each vertex. For each node 1<=i<=N there is added the following clause (of length K):

Vᵢ₁vVᵢ₂v . . . vV_{iK}

Subsequently, clauses are added that prevent solutions from assigning multiple colours to any node. For each vertex 1<=i<=N and for each pair of distinct colours 1<=k, m<=K we add the follow clause:

˜Vᵢₖv˜Vᵢₘ

Finally clauses are added to force solutions to assign distinct colours to adjacent nodes. For each pair of adjacent vertices (i,j) and each colour 1<=k<=K we add the following clause:

˜Vᵢₖv˜Vⱼₖ

In total there will be N+N*K*(K−1)+M*K clauses, where M is the number of edges in the graph. The skilled person will notice that there is a satisfying assignment to all N*K variables if and only if there is a solution to the GC problem as defined above. Therefore it is possible to solve the GC problem using a SAT solver that seeks satisfying valuations of CNF sentences.

The DPLL method proposed a simple procedure for recognising satisfiable CNF sentences on N variables. The method is essentially a depth first search over all possible 2^{N} valuations over the input sentence, with criteria to prune the search and transformation rules to simplify the sentence. The DPLL procedure is summarised as follows:

```
if Ω containes only unit clauses and no contradictions
then
  return YES
end if
if Ω contains an empty clause then
  return NO
end if
for all unit clauses ω ∈ Ω do
  Ω := UnitPropagate(Ω, ω)
end for
for all literals p such that [symbol]    p ∉ Ω do
  remove all clauses containing p from Ω
end for
p :=PickBranch(Ω)
return DPLL(Ω [symbol]     p) [symbol]     DPLL(Ω [symbol] [symbol]      p)
```

UnitPropagate simplifies Ω under the assumption p.

PickBranch applies a heuristic to choose a literal in Ω.

Embodiments of the invention may learn heuristics for the PickBranch (Ω) step of the DPLL method by optimizing over a family of the form:

$${arg max}_{p} f ( x , p ) \qquad ( 3 )$$

where x is a node in the search tree, p is a candidate literal, and f is a priority function mapping possible branches to real numbers. The state x will contain at least a CNF sentence and possibly pointers to ancestor nodes or statistics of the local search region.

Thus, as the DPLL algorithm is run, a decision heuristic (e.g., PickBranch when using the DPLL notation) is applied at each node of the search to determine which of the branches of the tree to explore next. The skilled person will appreciate that exploration of the tree 200 is likely to involve exploring branches that are not part a solution path and as such backtracking back up the search tree 200 is likely to occur. As such, the embodiment being described runs a DPLL depth first search on an nth training instance—step 604 of FIG. 6.

Embodiments of the invention are arranged to learn f from a sequence of sentences drawn from some distribution determined by a given application. This sequence of sentences may be thought of as being a training set, or a plurality of training instances, etc. For example, the sequence of sentences may be drawn from examples in hardware verification, or any of the other fields described herein, or the like. In practice such real-world sentences are drawn from a distribution that may result in efficient methods for their solution since such sentences are likely to have shared characteristics and substructures which allow learning to occur.

The embodiment being described identifies f with an element of a Hilbert space, H, the properties of which are determined by a set of statistics polynomial time computable from a SAT instance, Ω. Stochastic updates are then applied to the estimate of f in order to reduce our expected search time. xⱼ is used to denote a node that is visited as the DPLL method searches the tree, and φⱼ(xⱼ) to denote the feature map associated with instantiating literal pᵢ. Using reproducing kernel Hilbert space notation, our decision function at xⱼ takes the form:

$${arg max}_{i} {( f , {φ}_{i} ( {x}_{j} ) )}_{ℋ} . \qquad ( 4 )$$

The embodiment being described aims to learn f such that the expected search time is reduced. We define yᵢⱼ to be +1 if the instantiation of pᵢ at xⱼ leads to the shortest possible proof, and −1 otherwise. Typically therefore, it is advantageous if the learning procedure learns a setting of f that only instantiates literals for which yᵢⱼ is +1. We define a margin as follows:

max γs.t.<f,φᵢ(xⱼ)>_{H}−<f,φₖ(xₗ)>_{H}≧γ∀{(i,j)|yᵢⱼ=+1},{(k,l)|yₖₗ=−1} (5)

The skilled person will appreciate that yᵢⱼ is not completely known and the identity of yij is only known in the worst case after an exhaustive enumeration of all 2^{N} variable assignments. The DPLL method is a depth first search over literal valuations and for satisfiable sentences the length of the shortest proof is bounded by the number of variables. Consequently, in this case, all nodes visited on a branch of the search tree that resolved to unsatisfiable have yᵢⱼ=−1 and the nodes on the branch leading to satisfiable have yᵢⱼ=+1. As such embodiments of the invention may run the DPLL method with a current setting of f and if the sentence is satisfiable, update f using the inferred yᵢⱼ.

As such, embodiments of the invention are capable of computing in polynomial time valuations of satisfiable sentences in the following sense:
Theorem 1 ∃ a polynomial time computable φ with γ>0 [symbol] Ω belongs to a subset of satisfiable sentences for which there exists a polynomial time algorithm to find a valid valuation.

It should be noted that the argmax in each step of the DPLL method is computable in time polynomial in the sentence length by computing φ for all literals, and that there exists a setting of f such that there will be at most a number of steps equal to the number of variables.

The other direction of implication is shown by noting that we may run the polynomial method to find a valid valuation and use that valuation to construct a feature space with γ≧0 in polynomial time. That is, embodiments may choose a canonical ordering of literals indexed by i and let φᵢ(xⱼ) be a scalar. Then embodiments may set φᵢ(xⱼ)=+i if literal pᵢ is instantiated in the solution found by the polynomial method, −1 otherwise and when f=1, γ=2.

It is believed that similar substructures will exist in satisfiable and unsatisfiable sentences resulting from the same application (e.g., hardware verification or the like). Early iterations of embodiments of the invention may mistakenly explore branches of the search tree for satisfiable sentences and these branches will share characteristics with inefficient branches of proofs of unsatisfiability. Consequently, some embodiments of the invention may utilise proofs of unsatisfiability to additionally benefit from a learning procedure applied only to satisfiable sentences.

The embodiment being described uses a modified perceptron style update to provide the learning within the method. In such an embodiment, the DPLL search is run to completion with a fixed model, fₜ.

During the DPLL search, it is known that nodes on a path to a valuation that satisfies the sentence have positive labels 254, and those nodes that require backtracking have negative labels 252 as shown in FIG. 2. Thus, the solution path 204 (the nodes within the dotted boundary 204) comprise the shortest route from the root node 202 through the search tree 200 and comprises nodes marked with a positive label 254 and the DPLL search is run until a solution path 204 is or is not found for the nth training iteration—step 606.

If there is no solution then the search will run until the search tree 200 has been explored; i.e. until the search tree 200 resolution refutation proof has been completed.

Exploration of the search tree 200 may typically be deemed to have occurred when every branch of the search tree has been explored, or has been “pruned” such that exploration of that branch is deemed not necessary.

For example, a branch may be pruned when it is already clear that there cannot be a solution regardless of setting the remaining variables. For example, if a sentence begins “I-am-happy and I-am-not-happy and . . . ” then if we find such a contradiction, it really doesn't matter what occurs after the second “and,” the sentence cannot be TRUE. And the skilled person will appreciate that “happy” may be considered a variable in this sentence (e.g., happy AND its negation [symbol] happy).

In this Figure nodes of the search tree 200 labelled in the lighter grey result in backtracking and therefore have negative label 252 (e.g., −1), while those coloured in darker grey lie on the path to a proof of satisfiability and are therefore given a positive label 254 (e.g., +1).

If the sentence is satisfiable, a DPLL stochastic gradient, ∇_{DPLL} may be computed (e.g., the node are analysed to and the decision heuristic updated—step 608), and f can then be updated accordingly. That is, once the stochastic gradient has been computed, the decision heuristic is updated. In step 610, a decision is made as to whether the decision heuristic has changed (or in some embodiments the test may be as to whether the decision heuristic has changed more than a predetermined amount) the DPLL search is run on a further (e.g., n+1th) training instance—i.e. the method returns to step 604. On the other hand, if it is determined that the decision heuristic has not changed (or in some embodiments the decision heuristic has changed less than a predetermined amount) the training finishes step 612. As such, at that time a trained decision heuristic is generated and this trained decision heuristic may be used for determining satisfiability of CNF sentences from that class of real world problem. That is, if the training has been performed on hardware verification then the trained decision heuristic should be suitable for processing CNF sentences relating to hardware verification. The same applies to other fields.

Some embodiments of the invention may be arranged to determine that training has finished when the decision heuristic changes by less than a predetermined amount between iterations. Other embodiments may leave training enabled.

Referring to FIG. 3, it is possible to define two sets of nodes, S₊ and S₋, such that all nodes in S+ have positive label (e.g. +1) and lower score than all nodes in S₋. In the embodiment being described a sufficient condition is set which defines these sets by setting a score threshold T fₖ(φᵢ(xⱼ))<T∀(i,j)εS₊, fₖ(φᵢ(xⱼ))>T∀(i,j)εS₋ and |S₊|×|S₋| is maximised.

As such, the DPLL stochastic gradient update is defined as follows:

$$\begin{matrix}{∇}_{DPLL} = {\sum }_{( i , j ) ∈ {S}_{-}} \frac{{φ}_{i} ( {x}_{j} )}{\vert {S}_{-} \vert} - {\sum }_{( k , l ) ∈ {S}_{+}} \frac{{φ}_{k} ( {x}_{l} )}{\vert {S}_{+} \vert} & ( 6 ) \\ {f}_{t + 1} = {f}_{t} - η {∇}_{DPLL} & ( 7 )\end{matrix}$$

where η is a learning rate.

Thus, referring to equation (7), some embodiments may determine that training has finished when ∇DPLL changes by less than a predetermined amount between iterations.

However, in the embodiment being described a stochastic gradient decent function is to modify the decision heuristic which may not result in a steady training. Consequently there may be some training examples where no changes occur in ∇DPLL but subsequently there are changes. As such, if may be convenient to average ∇DPLL over a number of cycles. Such embodiments may determine that training has finished when the average of ∇DPLL stops changing. For example, training may be deemed to have finished when the average ∇DPLL (or in some embodiments ∇DPLL) was less than 10⁻⁸. The skilled person will appreciate that the absolute value at which training is deemed to have finished depends on the application to which the method is being applied.

Embodiments of the invention may be arranged to average ∇DPLL over substantially 100 iterations, 1000 iterations, or the like. This number of iteration over which ∇DPLL is averaged may or may not include iterations where ∇DPLL is zero (e.g., there is no change in that iteration).

In yet further embodiments, it is conceivable that training may be left enabled such that there fₜ₊₁ may potentially be updated after any search of the search tree 200. Such embodiments may be practical since the processing overhead to perform the learning update is much less than that to perform the search.

It will be appreciated that if the search of the tree 200 does not backtrack then there will be no update of ∇DPLL.

It should be noted that some embodiments of the invention initiate f₀ to emulate current SAT solvers which, in such embodiments, is likely to improve the performance of that method compared to an a priori setting of f₀.

### Proof of Convergence

R is defined to be a positive real value such that ∀i,j,k,l∥φᵢ(xⱼ)−φₖ( x̅ₗ)∥≦R

For any training sequence that is separable by a margin of size γ with ∥f∥=1, using the update rules in Equations (6)-(7) with η=1, the number of errors (updates) made during training on satisfiable sentences is bounded above by R²/γ².

If fₗ(φ(x))=0∀φ(x), then and considering the k^{th} element,

$$\begin{matrix}{‖ {f}_{k + 1} ‖}^{2} = {‖ {f}_{k} - {∇}_{DPLL} ‖}^{2} \\ = {‖ {f}_{k} ‖}^{2} - 2 ( {f}_{k} , {∇}_{DPLL} ) + {‖ {∇}_{DPLL} ‖}^{2} \\ \leq {‖ {f}_{k} ‖}^{2} + 0 + {R}^{2} ,\end{matrix} \qquad ( 8 )$$

It is noted that it is the case (fₖ, ∇_{DPLL})≧0 for any selection of training examples such that the average of the negative examples (e.g., those nodes labelled negatively) score higher than the average of positive examples (e.g., those nodes labelled positively) generated by running a DPLL search. It is possible that some negative examples (e.g., negatively labelled nodes) with lower scores than the some positive nodes will be visited during the depth first search of the DPLL method, but at least one of them will have higher score. Similarly, some positive examples may have higher scores than the highest scoring negative example. In both cases, we may simply discard such instances from the training method, as described above, giving the desired inequality. By induction ∥fₖ₊₁∥²≦kR².

Let u be an element of 'H that obtains a margin of γ on the training set then a lower bound is obtained:

<u,fₖ₊₁>=<u,fₖ>−<u,∇_{DPLL}>≧<u,fₖ>+γ (9)

As such, it can be determined that −<u, ∇_{DPLL}>≧γ because the means of the positive and negative training example lie in the convex hull of the positive and negative sets, respectively, and u achieves a margin of γ. Then by induction <u, fₖ₊₁>≧kγ.

Combining the two results yields:

\sqrt{kR}≧∥fₖ₊₁∥≧<u,fₖ₊₁>≧kγ (10)

which can be rearranged to give k≦(R/γ)².

It is noted that each node xⱼ consists of a CNF sentence Ω together with a valuation for zero or more variables. The feature function φ(x; p) maps a node x and a candidate branching literal p to a real vector φ. In the prior art, many heuristics used to determine the branching strategy during the DPLL search involve counting occurrences of literals and variables. For notational convenience let C(p) be the number of occurrences of p in Ω and let Ck(p) be the number of occurrences of p among clauses of size k and as such the following table can be used to summarise the feature space. Features are computed as a function of a sentence Ω and a literal p. q implicitly refers to the variable within p. Thus, heuristics used in prior art solvers are summarised in the following table:

| | Dimen- | |
|---|---|---|
| Feature | sions | Description |
| is-positive | 1 | 1 if p is positive, 0 otherwise |
| lit-unit-clauses | 1 | C₁(p), occurences of literal in unit clauses |
| var-unit-clauses | 1 | C₁(q), occurences of variable in unit clauses |
| lit-counts | 3 | C [symbol] (p) for i = 2, 3, 4, occurences in small |
| | | clauses |
| var-counts | 3 | C [symbol] (q) for i = 2, 3, 4, as above, by variable |
| bohm-max | 3 | max(C [symbol] (p), C [symbol] (−p)), i = 2, 3, 4 |
| bohm-min | 3 | min(C [symbol] (p), C [symbol] (−p)), i = 2, 3, 4 |
| lit-total | 1 | C(p), total occurences by literal |
| neg-lit-total | 1 | C(−p), total occurences of negated literal |
| var-total | 1 | C(q), total occurences by variable |
| lit-smallest | 1 | Cₘ(p), where m is the size of the smallest |
| | | unsatisfied clause |
| neg-lit-smallest | 1 | Cₘ(−p), as above, for negated literal |
| jw | 1 | J(p) Jeroslow-Wang cue, see main text |
| jw-neg | 1 | J(−p) Jeroslow-Wang cue, see main text |
| activity | 1 | minisat activity measure |
| time-since- | 1 | t − T(p) time since last activity (see main text) |
| active | | |
| has-been-active | 1 | 1 if this p has ever appeared in a conflict |
| | | clause, 0 otherwise |

[symbol]

indicates data missing or illegible when filed

However, the table above also summaries the feature space of an embodiment of the invention. In other embodiments the feature space may be comprised by any other grouping of components which may or may not be heuristics used in other solvers). Embodiments being described processes each of the components of the feature space at each node of the search tree and subsequently learns a weighting function which modifies the contribution of each of the components to the overall heuristic. Specifically, some embodiments may make branching decisions by maximising the dot product of the feature space vector and a weighting function vector. Other embodiments may not use a vector dot product and may instead use a non-linear function; such as a positive definite kernel. Thus, each of the weighting function vector and the feature space vector may be thought of as being vectors of statistical features associated with each branch.

Thus, each of the individual components of the selected feature space have been based upon the heuristics of some of the most successful SAT solvers. However, due to the nature of embodiments of the invention the heuristics within the feature space can be set to emulate many other systems for particular priority functions f. As such, embodiments of the invention may use different heuristics to those shown in the table above and the table exemplifies features that may be used.

Comments can be made about some of the heuristics in the above table as follows.

“lit-total” and “neg-lit total” capture two cues, based directly on literal counts, the first of which is to branch on the literal that maximises C(p) and the second is to maximise C(p)+C( [symbol] p).
“lit-smallest” aims to identify the size of the smallest unsatisfied clause (m=min|ω|, ωεΩ) and then identifies the literal appearing most frequently amongst clauses of size m. “neg-lit-smallest” works in the same manner as “lit-smallest” but processes the negated literal ( [symbol] p).

α max(Cₖ(p,xⱼ),Cₖ( [symbol] p,xⱼ))+β min(Cₖ(p,xⱼ),Cₖ( [symbol] p,xⱼ)), (11)

“jw” and “jw-neg” use voting schemes in which clauses vote for their components with weight 2^{-k}, where k is the length of the clause. The total votes for a literal p is where the sum is over ω clauses that contain p as in equation 12.

J(p)=Σ2^{-|ω|} (12)

In the embodiment being described the “jw” heuristic maximises J(p) whilst “jw-neg” maximises j( [symbol] p).

Embodiments of the invention may use Boolean constraint propagation (BCP) which is advantageous since it can speed up the search process. One component of BCP generates new clauses as a result of conflicts encountered during the search. As such, embodiments of the invention may use an elapsed time since a variable was last added to a conflict clause to measure the “activity” of that variable (e.g., an activity related measure). Empirically, it is noted that resolving variables that have most recently appeared in conflict clauses results in an efficient search.

Embodiments of the invention use a feature vector which contains one or more activity related measure. In one particular embodiment, an activity related measure may be computed as follows. Each decision, at a node during the DPLL search, is given a sequential time index t. After each decision we update a table which is arranged to keep a track of the most recent activity: T(p):=t for each p added to a conflict clause during that iteration. In particular embodiments may be arranged to include, within the table, the difference between the current iteration and the last iteration at which a variable was active. This can be referred to as a feature “time-since-active”. The table may also be arranged to include the Boolean feature “has-been-active” to indicate whether a variable (of the Boolean expression) has ever been active.

The skilled person will note that some of the heuristics in the above table rely on elements of the table (activity, time-since-active, has-been-active).

The skilled person will appreciate that disjunctions containing at most one positive literal may be referred to as a Horn clause:

[symbol]

q₁ [symbol] . . . [symbol] [symbol] qₖ₋₁ [symbol] qₖ (13)

### Proof of Horn Margin

Further, a sentence Ω is a Horn formula if it is a conjunction of Horn clauses. It is known that methods exists which determine the satisfiability of Horn formulae within polynomial time. One method based on unit propagation operates as follows. If there are no unit clauses in Ω then Ω is trivially satisfiable by setting all variables to false. Otherwise, let {p} be a unit clause in Ω. The method then deletes any clause from Ω that contains p and removes [symbol] p wherever it appears. This replacement is repeated until either a trivial contradiction q̂ [symbol] q is produced (in which case Ω is unsatisfiable) or until no further simplification is possible (in which case Ω is satisfiable).

It is possible to show that the feature space used in embodiments of this invention has a margin for Horn clauses by showing that for a particular priority function f₀, the method emulates the unit propagation method discussed above.

If f₀ is set to be zero everywhere except for the following elements: “is-positive”=−ε, “lit-unit-clauses”=1. Let H be the decision heuristic corresponding to f₀.

Consider a node x and let Ω be the input sentence Ω₀ simplified according to the (perhaps partial) valuation at x. If Ω contains no unit clauses then [symbol] φ(x, p), f₀ [symbol] will be maximized for a negative literal p= [symbol] q. If Ω does contain unit clauses then for literals p which appear in unit clauses we have [symbol] φ(x, p), f₀ [symbol] ≧1, while for all other literals we have [symbol] φ(x, p), f₀ [symbol] <1. Therefore H will select a unit literal if Ω contains one.

For satisfiable Ω, this exactly emulates the unit propagation method, and since that method does not tracks, the method makes no mistakes.

For unsatisfiable Ω the method behaves as follows. First it is noted that every sentence encountered contains at least one unit clause, since, if not, that sentence would be trivially satisfiable by setting all variables to false and this would contradict the assumption that Ω is unsatisfiable. As such, at each node x of the search tree, the method first branches on a unit clause p, then later will backtrack to x and branch on [symbol] p. But since p appears in a unit clause at x this will immediately generate a contradiction and no further nodes will be expanded along that path of the search tree. Therefore the method expands no more than 2N nodes, where N is the length of Ω.

### 2SAT Margin

A 2-CNF sentence is a CNF sentence in which every clause contains exactly two literals.

It can be shown that the feature space used by embodiments of the invention can recognise 2-CNF sentences in polynomial time. If there are no unit clauses in Ω then it is possible to pick any literal and add it to Ω. Otherwise, let {p} be a unit clause in Ω and apply unit propagation to p as described above. If a contradiction is generated then back-track to the last branch of the search tree and negate the literal added there, or, if there is no such branch, then the Ω is unsatisfiable. It can be shown that such a method does not back-track over more than one branch, and therefore completes in polynomial time.

Let f₀ be zero everywhere except for the element corresponding to the “appears-in-unit-clause” feature, which is 1. As such, the method branches on unit literals whenever one is present, and branches on an arbitrary literal in other cases. This behaviour emulates the behaviour described in relation to the 2-CNF sentences described above, and hence completes in polynomial time for all 2-SAT sentences.

These special cases indicate a property of the computational complexity of feature spaces with non-negative margin. In particular if a subset of SAT is polynomial time solvable with complexity Θ(n^{m}), any feature map with non-negative margin has a lower bound on its complexity Ω(n^{m-1}).

### Results

### Graph Colouring

Embodiments of the invention were applied on the problem of planar graph colouring, in which the aim is to colour regions of a map such that neighbouring regions are not coloured with the same colour, for which methods are known which can be solved in polynomial time. The method was applied with up to four colours which should ensure that all instances were satisfiable.

To test the method a ‘map’ was generated by creating an empty L×L grid and sampling K cells at random which were labelled 1 . . . K. The method then repeatedly picked a labelled cell with at least one unlabelled neighbour and copied its label to its neighbour until all cells were labelled. Next a K×K adjacency matrix A was formed with Aᵢⱼ=1 if there is a pair of adjacent cells with labels i and j. Finally a SAT sentence over 4K variables was generated (each variable corresponds to a particular colouring of a particular vertex), with clauses expressing the constraints that each vertex is assigned one and only one colour and that no pair of adjacent vertices may be assigned the same colour.

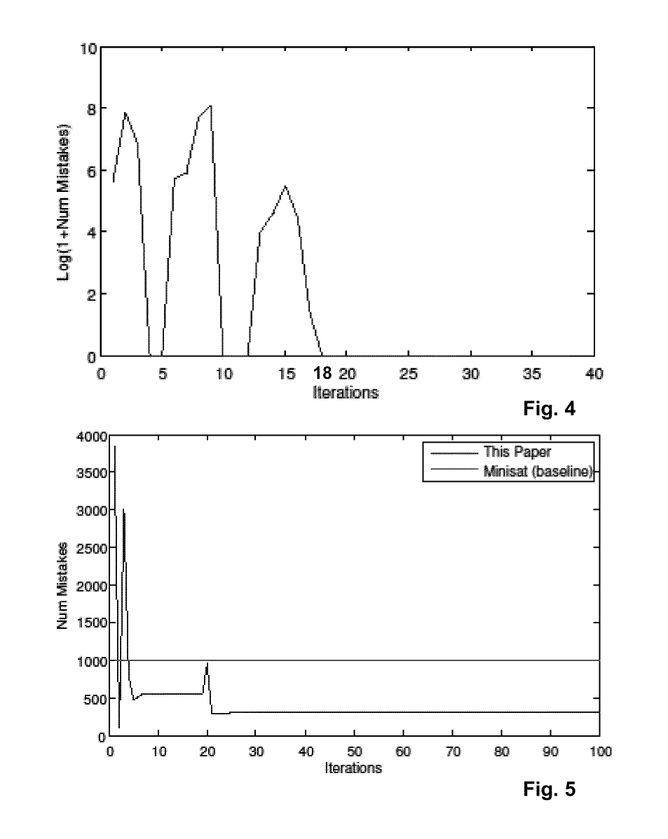

In our experiments we used K=8, L=5 and a learning rate of 0.1. The method ran over 40 training iterations (e.g., over a set of training instances) and no training instance was repeated. The number of mistakes (branching decision that were later reversed by back-tracking) made at each iteration is shown in FIG. 4. It is noted that the method converged after 18 iterations and after 18 iterations no mistakes were made.

Planar graph colouring is a known polynomial time computable problem, but it is difficult to characterize theoretically and an automated theorem prover was employed in the proof of polynomial solvability.

### Hardware Verification

The embodiment being described has been further tested by applying it to a selection of problems from a SAT competition in which the input sentence related to hardware verification. Training and validation examples were selected from the same suite of problems; this is in line with the goal of learning the statistical structure of particular subsets of SAT problems. In particular, the problems selected for training and validation are from the 2003 SAT competition (http://www.satcompetition.org/2003/) and are listed in the following table.

| | |
|---|---|
| Training | Validation |

| Problem | Clauses | Problem | Clauses |
|---|---|---|---|
| ferry11 | 26106 | ferry10 | 20792 |
| ferry11u | 25500 | ferry10u | 20260 |
| ferry9 | 16210 | ferry8 | 12312 |
| ferry9u | 15748 | ferry8u | 11916 |
| ferry12u | 31516 | ferry12 | 32200 |

The method was applied on each of the five training problem sequentially for a total of 8 passes through the training set (40 iterations in total). A perceptron update was performed after solving each problem. After each update the current priority function f(p) was evaluated on the entire validation set. The average mistake rate on the validation set are shown for each training iteration in FIG. 5.

It is appreciated that whilst in the embodiment being described, an update is performed after each training iteration, other embodiments may run a plurality of training instances before the decision heuristic is updated; i.e. learning is performed.

The hardware verification problem explored in FIG. 5 shows that the method of embodiments of the invention learns a setting of f that gives performance an order of magnitude faster than the prior art as exemplified by the Minisat solver (http://minisat.se). It does so after relatively few training iterations (roughly 5 iterations) and then maintains good performance.

In some embodiments of the invention learning is performed on positive examples if the subset of SAT sentences generated by the method have a positive margin.

However other embodiments may also employ learning in the absence of a positive margin. In such an embodiment learning may be accelerated by making updates based on unsatisfiable sentences. One potential approach would be to consider a stochastic finite difference approximation to the risk gradient by running the DPLL search a second time with a perturbed f. Additionally, embodiments may consider updates to f during a run of the DPLL search when the method backtracks from a branch of the search tree for which we can prove that all yᵢⱼ=−1. Such embodiments may ensure that the implicit empirical risk minimization is not biased.

Some embodiments of the invention may consider a computation of the feature map that is independent of all other computations. Other embodiments may improve computational complexity by considering dynamic programming approaches in which feature maps may use computation expended at a parent or sibling node.

The above embodiments describe that a search is run through the search tree before updates to the decision heuristic is made. Other embodiments may be arranged to update the decision heuristic as the search progresses.

1. A computer implemented method arranged to indicate whether a Conjunctive Normal Form (CNF) sentence representing a physical system is satisfiable by learning a decision heuristic from a set of training instances, the method comprising causing the computer to receive data representing the CNF sentence and to structure a search tree based upon that data, the search tree comprising a root node and a plurality of other nodes, the method subsequently comprises causing the computer to:
a. use a search to visit nodes of the tree thereby searching the search tree, wherein the search uses a decision heuristic at each node to determine which of the branches of the search tree to explore from that node, where the search is run on one of the set of training instances until a solution path, providing the shortest route from the root node through the search tree to a solution node is located;
b. analyse the nodes visited during the search of the tree to determine which nodes lie on the solution path;
c. modify the decision heuristic according to the analysis in step b;
d. repeat the method on a further training instances such that a trained decision heuristic is generated; and
e. subsequently use the trained decision heuristic to process CNF sentences in addition to the training set to determine whether those CNF sentences are satisfiable.

2. A method according to claim 1 in which the decision heuristic comprises selecting a branch of the search tree according to a function of a vector of statistical features associated with each branch.

3. A method according to claim 2 in which the decision heuristic comprises maximising the function of the vector of statistical features.

4. A method according to claim 3 in which the function is maximised by a learning process in step c of the method.

5. A method according to claim 1 in which the decision heuristic comprises a non-linear function which is learnt during step c.

6. A method according to claim 1 which step c uses a gradient decent step on an objective function in order modify the decision heuristic.

7. A method according to claim 1 which provides a plurality of CNF sentences from a predetermined problem area wherein characteristics shared between the sentences allow training and consequent modification of the decision heuristic to occur.

8. A method according to claim 1 which uses the Davis-Putnam-Logemann-Loveland (DPLL) method to perform the search.

9. A method according to claim 8 in which decision heuristic is used within the PickBranch step of the DPLL method.

10. A method according to claim 1 in which modification of the decision heuristic in step c. is by statistical learning.

11. A method according to claim 10 in which the statistical learning is by way of risk minimization or Baysian inference.

12. A method according to claim 10 in which the learning is by way of perceptron learning.

13. A computer system arranged to provide the method of claim 1.

14. A machine readable medium containing instructions which when read by a machine cause that machine to decide satisfiability (SAT) of CNF sentences by causing the machine to structure a satisfiability solver as a search tree comprising a root node and a plurality of other nodes and which subsequently cause the machine to use a search to visit nodes of the tree thereby searching the search tree and in which a decision heuristic is used at each node, during the search, to determine the order in which to search the branches of the search tree, the decision heuristic being learnt by the machine from a plurality of training instances, where the instructions further cause the machine to:
a. run the search on one of the plurality of training instances until a solution path, providing the shortest route from the root node through the search tree to a solution node, is located;
b. analyse the nodes visited during the search of the tree to determine which nodes lie on the solution path;
c. modify the decision heuristic according to the analysis in step b; and
d. repeat the method on a further training instances such that a trained decision heuristic is generated.

15. A medium according to claim 14 in which the instructions cause the machine to select a branch of the search tree that maximizes a function of a vector of statistical features associated with each branch.

16. A medium according to claim 15 in which the instructions cause the machine to maximise the function of the vector of statistical features.

17. A medium according to claim 15 in which the instructions cause the machine to maximise the overall heuristic by a learning process in step c of the method.

18. A medium according to claim 14 in which the instructions cause the machine to use a non-linear function as the decision heuristic which is learnt during step c.

19. A medium according to claim 14 in which the instructions cause the machine to use a gradient decent function, in step c, to modify the decision heuristic.

20. A medium according to claim 14 in which the instructions cause the machine to process a plurality of CNF sentences from a predetermined problem area as the plurality of training instances, wherein characteristics shared between the sentences allow training and consequent modification of the decision heuristic to occur.

21. A medium according to claim 14 in which the instructions cause the machine to use the Davis-Putnam-Logemann-Loveland (DPLL) method to perform the search.

22. A medium according to claim 21 in which the instructions cause the machine to use the decision heuristic within the PickBranch step of the DPLL method.

23. A medium according to claim 14 in which the instructions cause the machine to modify the decision heuristic in step c. is by statistical learning.

24. A medium according to claim 23 in which the instructions cause the machine to modify the decision heuristic in step c. by way of risk minimization or Baysian inference.

25. A medium according to claim 23 in which the instructions cause the machine to use perceptron learning to modify the decision heuristic in step c.
